(19) United States
(12) Patent Application Publication
(10) Pub. No.: US 2005/0182582 A1
(43) Pub. Date: Aug. 18, 2005

(54) Adaptive resource monitoring and controls for a computing system

(75) Inventor: James N. Chen, Austin, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/777,648

(22) Filed: Feb. 12, 2004

(51) Int. Cl. G06F 19/00

(52) U.S. Cl. 702/108

(57) ABSTRACT

The invention, in its various aspects and embodiments, is a method and apparatus for monitoring the performance of a computing system. The method comprises receiving data associated with monitoring performance of at least a portion of the computing device in accordance with a monitoring scheme; detecting a pattern in the received data; and autonomously adapting the monitoring scheme responsive to the detected pattern. The apparatus may include a computing apparatus programmed to perform such a method for monitoring the performance of a computing system. The apparatus may also, in another aspect, include a program storage medium encoded with instructions that, when executed by a computing device, perform such a method for monitoring the performance of a computing system.

### BACKGROUND OF THE INVENTION

1. Field of the Invention

This invention relates generally to managing the performance of a computing system, and, more particularly, to adaptively monitoring resource usage in a computing system.

2. Description of the Related Art

Computing systems have evolved into what are now known as “enterprise computing systems.” An enterprise computing system is typically a large number of computing and storage devices that are employed by users of an “enterprise.” One popular type of enterprise computing system is an “intranet,” which is a computing system that operates like the Internet, but requires special authorization to access. Such access is typically only granted to employees and/or contractors of the enterprise. However, not all enterprise computing systems are intranets or operate along the principles of the Internet.

One concern regarding an enterprise computing system is controlling its operation to promote efficient utilization of its computing resources. Increasing size and complexity generally increases difficulty in managing the operation of computing systems. Even relatively modestly sized computing systems can quickly overwhelm the ability of an operator to effectively manage. For instance, in a technique known as “load balancing,” the processing loads of selected portions of the computing system are monitored. If a node becomes “overloaded” or is in danger of being swamped, some of the processing load is switched to another node whose processing capacity is not as challenged. Processing tasks therefore do not needlessly wait in a queue for one processing node while another processing node idles. This increases efficiency by reducing the time necessary for performing processing tasks. Anticipating problem scenarios by recognizing pathological resource utilization patterns enables one to take corrective action and avert major problems.

However, the implementation techniques such as load balancing generally depend on the acquisition of statistical data, or “metrics,” about the operation of the various parts of the computing system. The larger and more powerful the computing system, the more data there is to collect and, therefore, analyze. In some instances, even modestly sized computing systems produce more data than can be collected and analyzed manually in any reasonable period of time. The art has therefore developed a number of tools for automatically monitoring and controlling the operation of computing systems. However, these automated tools require human intervention and interaction in all phases of their operation since a tool needs to now what to monitor, when to monitor, and how often to sample operations, depending on the load applied to the computing system.

Monitoring and control tools are commonly based on static, or pre-configured, data. An operator configures the tool to monitor some fixed set of statistics and some fixed frequency. Once a system is configured to monitor a fixed set of resources at a given frequency, those fixed sets of statistics are monitored at that frequency until a user targets another set of statistics or frequency. Sampling controls are typically set by experienced administrators or analysts based on empirical data. Typically, a monitoring system over-samples (and add processing and resource storage overhead) or under-samples (missing valuable diagnostic data) based on this kind of static monitoring.

The present invention is directed to addressing, or at least reducing, the effects of, one or more of the problems set forth above.

### SUMMARY OF THE INVENTION

The invention, in its various aspects and embodiments, is a method and apparatus for monitoring the performance of a computing system. The method comprises receiving data associated with monitoring performance of at least a portion of the computing device in accordance with a monitoring scheme; detecting a pattern in the received data; and autonomously adapting the monitoring scheme responsive to the detected pattern. The apparatus may comprise a computing apparatus programmed to perform such a method for monitoring the performance of a computing system. The apparatus may also, in another aspect, comprise a program storage medium encoded with instructions that, when executed by a computing device, perform such a method for monitoring the performance of a computing system.

### BRIEF DESCRIPTION OF THE DRAWINGS

The invention may be understood by reference to the following description taken in conjunction with the accompanying drawings, in which like reference numerals identify like elements, and in which:

FIG. 1 conceptually depicts a computing system managed in accordance with the present invention.

FIG. 2 depicts, in a block diagram, selected portions of a computing device with which certain aspects of the present invention may be implemented.

FIG. 3 illustrates a method practiced in accordance with one particular embodiment of the invention by the performance tool of the computing device in FIG. 2 with respect to the computing system of FIG. 1.

FIG. 4 conceptually depicts one particular implementation of one embodiment of a computing system alternative to that shown in FIG. 1 managed in accordance with the present invention.

FIG. 5 depicts, in a block diagram, selected portions of a computing device with which certain aspects of the present invention may be implemented to manage the computing system of FIG. 4.

FIG. 6 depicts, in a block diagram, selected portions of a performance tool operating in accordance with the present invention residing on the computing apparatus of FIG. 5 and monitoring the performance of the computing system in FIG. 4.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

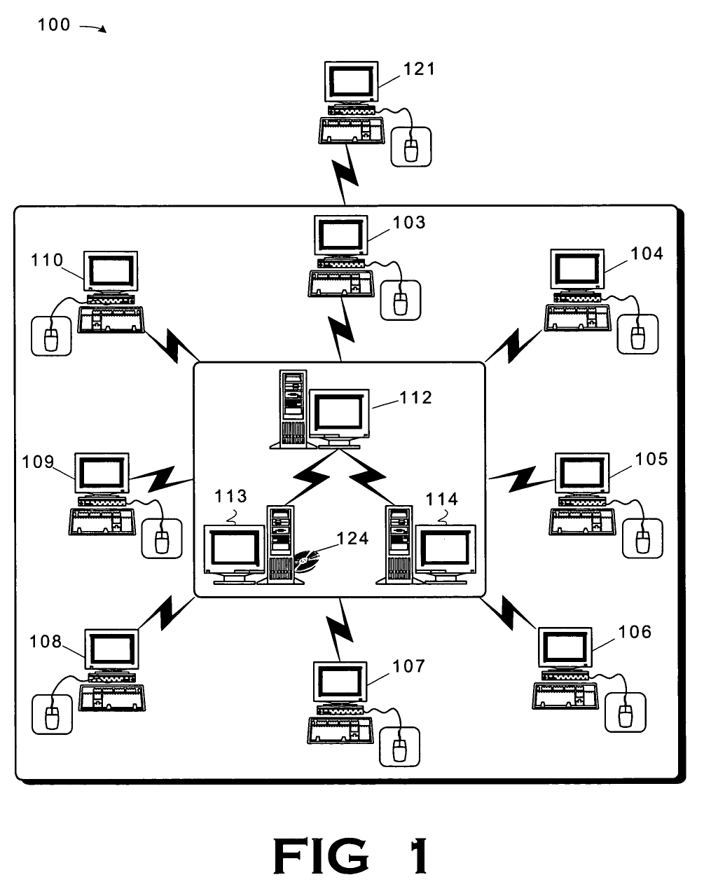

FIG. 1 illustrates an exemplary computing system 100 managed in accordance with the present invention. The computing system 100 comprises a plurality of computing devices, e.g., the workstations 103-110 and the servers 112-114. Note that the number and composition of the computing devices that constitute the computing system 100 is not material to the practice of the invention. The computing system 100 may include, for instance, peripheral devices such as printers (not shown) and may include other types of computers, such as desktop personal computers. The invention admits wide variation in implementing the computing devices, and all manner of computing devices may be employed. For instance, personal computers (desktop or notebook) and personal digital assistants (“PDAs”) may be used in addition to or in lieu of the workstations 103-110. For another example, the servers 112-114 might also be implemented as rack mounted blade servers in some embodiments. In the illustrated embodiment, the computing system 100 is an enterprise computing system, and so may include a large number of computing devices.

The computing system 100 is, in the illustrated embodiment, a network, i.e., a group of two or more computer systems linked together. Networks can be categorized by the scope of the geographical area of their constituent computing devices:
local-area networks (“LANs”), in which the computing devices are located in relatively close proximity (e.g., in the same building);
wide-area networks (“WANs”), in which the computing devices are farther apart than in a LAN and are remotely connected by landlines or radio waves;
campus-area networks (“CANs”), in which the computing devices are within a limited geographic area, such as a university or research campus or a military base;
metropolitan-area networks (“MANs”), in which the computers are distributed throughout a municipality or some within some reasonable proximity thereto; and
home-area networks (“HANs”), in which the computing devices are located within a user's home and connects a person's digital devices.
   Note that these categorizations are not particularly distinct, and memberships may overlap. For instance, a HAN may be a LAN and a CAN may be a WAN.

Other, less common categorizations are sometimes also used. Networks can be categorized by their functionality, as well. For instance, functionality categorizations include:
content delivery networks (“CDNs”), or networks of servers that deliver a Web page to a user based on geographic locations of the user, the origin of the Web page and a content delivery server; and
storage area networks (“SANs”), or high-speed subnetworks of shared storage devices available to various servers on, for example, a LAN or a WAN to free servers from data storage responsibilities.
   Networks can also be categorized by characterizations drawn from their implementation other than their physical scope. For instance, networks can be categorized by their:
topology, or the geometric arrangement of a computer system, (e.g., a bus topology, a star topology, or a ring topology);
protocol, or the common set of rule specifications that define the types, numbers, and forms for signals used to communicate among the computing devices (e.g., Ethernet or the IBM token-ring protocols); and
architecture, or the structure of communications among the computing devices (e.g., a peer-to-peer architecture or a client/server architecture).
   Still other physical characteristics may be employed.

As an enterprise computing system, the computing system 100 may comprise many sub-networks falling into one or more of the network categorizations set forth above. For instance, an enterprise computing system may comprise several CANs, each of which include several WANs that interface with HANs through which employees or contractors work. The WANs may include SANs and CDNs from and through which the user extracts information. Some of the WANs may have peer-to-peer architectures while others may have client/server architectures. The computing system 100, in the illustrated embodiment, may be expected to exhibit one or more of these characteristics described above. Note that, in the illustrated embodiment, the computing system 100 employs a client/server architecture.

Note, however, that the present invention is not limited to application in enterprise computing systems, or even in networks. The invention may be employed on a single computing device, e.g., the server 112, to monitor its performance only. Or, the invention may be employed on a group of computing devices that are not networked, e.g., a personal computer, with a dedicated printer and a webcam. Nevertheless, it is generally anticipated that the advantages and benefits provided by the present invention may be more fully enjoyed as the size and complexity of the monitored computing system increase.

FIG. 1 also includes a computing apparatus 121 that may comprise a portion of the computing system 100, or may stand alone. In the illustrated embodiment, the computing apparatus 121 stands alone. Furthermore, the functionality associated with the computing apparatus 121, as described below, may be distributed across the computing system 100 instead of centralized in a single computing device. The computing apparatus 121 is implemented in the illustrated embodiment as a workstation, but may be some other type of computing device, e.g., a desktop personal computer.

FIG. 2 depicts, in a block diagram, selected portions of the computing apparatus 121, including a control unit, i.e., a computing device such as a processor 203, communicating with a program storage medium, i.e., the storage 206, over a bus system 209. The processor 203 may be any suitable kind of processor known to the art, e.g., a digital signal processor (“DSP”), a graphics processor, or a general purpose microprocessor. In some embodiments, the processor 203 may be implemented as a processor set, such as a microprocessor with a graphics or math co-processor. The bus system 209 may operate in accordance with any suitable protocol known to the art. The storage 206 may be implemented in conventional fashion and may include a variety of types of storage, such as a hard disk and/or RAM and/or removable storage such as the magnetic disk 212 and the optical disk 215. The storage 206 will typically include both read-only and writable memory, implemented in disk storage and/or cache. Parts of the storage 206 will typically be implemented in magnetic media (e.g., magnetic tape or magnetic disk) while other parts may be implemented in optical media (e.g., optical disk). The present invention admits wide latitude in implementation of the storage 206 in various embodiments.

The storage 206 is encoded with one or more data structures (not shown) in a data storage 220 containing data employed in the present invention as discussed more fully below. The storage 206 is also encoded with an operating system 221 and some interface software 224 that, in conjunction with the display 227, constitute an user interface 230. The display 227 may be a touch screen allowing the user to input directly into the computing apparatus 121. However, the user interface 230 also may include peripheral input/output (“I/O”) devices such as the keyboard 233, the mouse 236, or the stylus 239.

The processor 203 runs under the control of the operating system 221, which may be practically any operating system known to the art. The illustrated embodiment employs a UNIX operating system, but may be, for example, a WINDOWS-based operating system in alternative embodiments. The processor 203, under the control of the operating system 221, invokes the interface software 224 on startup so that the user (not shown) can control the computing apparatus 121. In the illustrated embodiment, the user interface 230 comprises a graphical user interface (“GUI”), although other types of interfaces may be used.

A performance tool 242 resides in the storage 206 in accordance with the present invention. The performance tool 242 is invoked by the processor 203 under the control of the operating system 221 or by the user through the user interface 230. As will be discussed in greater detail below, the performance tool 242 implements the method of the present invention. The performance tool 242 can be configured so that it is invoked by the operating system 221 on startup or so that a user can manually invoke it through the user interface 230.

As mentioned above, the functionality associated with the computing apparatus 121 may be distributed across a computing system instead of being centralized in a single computing apparatus as in the illustrated embodiment. Thus, alternative embodiments may, for instance, distribute the performance tool 242 and the data it operates on across, for example, the computing systems 100 (shown in FIG. 1). For example, in the illustrated embodiment, each workstation 103-110 and server 112-114 transmits data pertaining to its performance to the computing apparatus 121, which stores it in a single, global repository. Other embodiments, however, may store data pertaining to its own performance in its own storage 206 instead of sending it to the computing apparatus 121. The performance tool 242, in such an embodiment, would then need to access the performance data through the computing system 100. However, the illustrated embodiment centralizes these components on a single computing apparatus 121 to clarify the illustration and thereby facilitate the disclosure of the present invention.

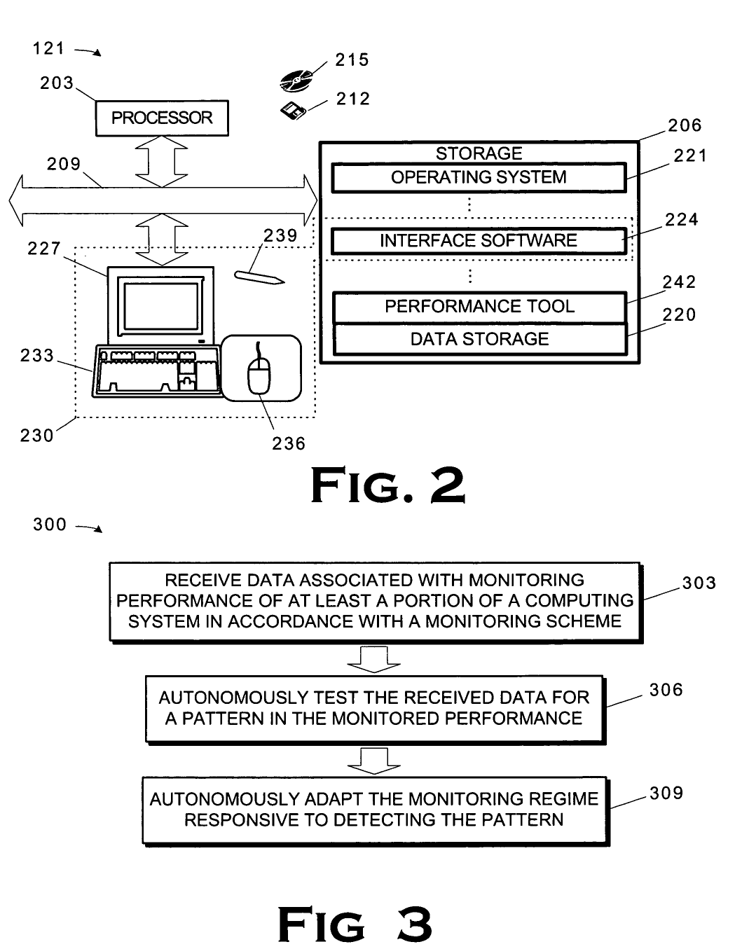

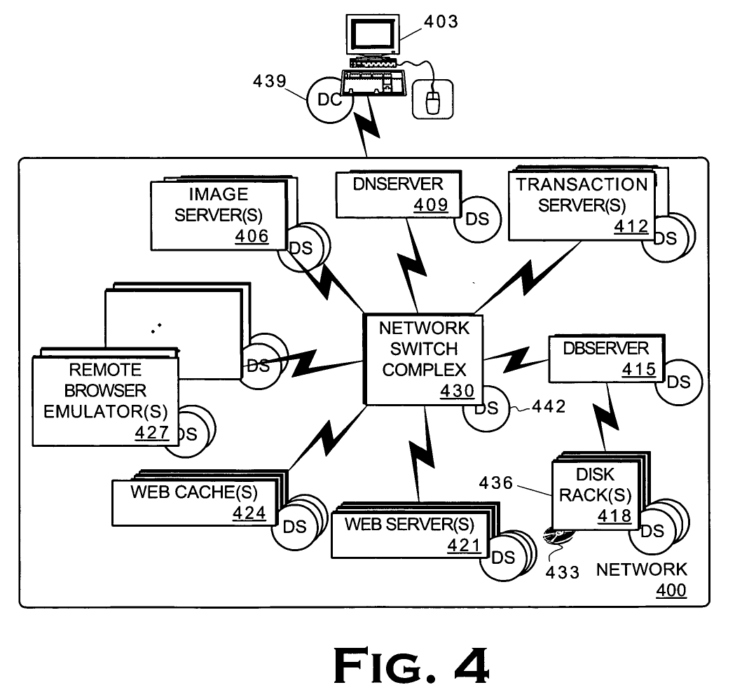

FIG. 3 illustrates one particular embodiment of a method 300 for monitoring the performance of a computing system 100. In the illustrated embodiment the performance tool 242 implements the method 300 in accordance with the present invention. The method 300 assumes that a monitoring scheme has already been established and is collecting data regarding the performance of the computing system 100. The establishment of a monitoring scheme will be implementation specific, and one such implementation is discussed below. In general, however, various computing resources in the computing system 100 are instrumented to collect various metrics regarding that resource and at a certain sampling frequency. Such instrumentation is known to the art, and any suitable technique may be employed. In the illustrated embodiment, the resource monitoring employs a manager/agent relationship between the computing apparatus 121 and the computing system 100. One such relationship is disclosed more fully in U.S. Pat. No. 5,432,932, entitled “System and Method for Dynamically Controlling Remote Processes from a Performance Monitor”, issued Jul. 11, 1995, to International Business Machines Corporation as assignee of the inventors Chen, et al., and commonly assigned herewith. However, this is not necessary to the practice of the invention.

The method 300, illustrated in FIG. 3, begins with the performance tool 242 receiving (at 303) data associated with monitoring performance of at least a portion of the computing system 100 in accordance with a monitoring scheme. The data should be in canonical form, so that the least amount of comparison is needed to implement the present invention. The type and volume of the data received will depend on a variety of factors well known to the art, such as the types of the resources, the available instrumentation for the given resources, and frequency with which the performance is sampled. In the illustrated embodiment, the performance tool 242, shown in FIG. 2, receives the data and stores it in the data storage 220.

Returning to FIG. 3, the method 300 proceeds with the performance tool 242, shown in FIG. 2, autonomously testing (at 306) the received data for a pattern in the monitored performance. In one particular embodiment discussed further below, the performance tool 242 compares one or more of the sets of the received data against one or more of the previously developed pattern signatures (not shown). The pattern signatures typically represent performance patterns associated with known, undesirable performance pathologies. However, the performance patterns may be interesting for other reasons. For instance, the performance patterns may be useful in predicting the behavior of various applications running on the computing system 100 and preemptively adapting the monitoring scheme (as described below) in anticipation of that behavior.

The method 300, as is shown in FIG. 3, continues by autonomously adapting the monitoring scheme responsive to detecting the pattern. The term “autonomous” implies under software control and/or direction without direct human intervention. In the illustrated embodiment, upon detecting a correlation between the data in one or more sets of received data and one or more pattern signatures, the performance tool 242, shown in FIG. 2, produces a recommended course of action for adapting the monitoring scheme. In some instances, the performance tool 242 may produce multiple recommendations depending on the degree of correlation of the data to, for example, pattern signatures, as described more fully below. Where multiple recommendations are proffered, the performance tool 242 may rank them depending on some predetermined criteria. For example, if the data indicates that a pathology is developing that might be any one (or more) of the potential pathologies associated with several of the pattern signatures. The performance tool 242 can recommend a course of action for each of the potential pathologies identified by the pattern signatures and rank the recommendations by the likelihood that the developing pathology is that particular potential pathology.

In some embodiments, the recommended course of action may be designed to elicit additional or different data to more accurately identify a developing pathology. Consider, for instance, the scenario presented immediately above in which the developing pathology may be any one of several different potential pathologies. Some of these potential pathologies may be remedied by very different courses of action, some of which might exacerbate other potential pathologies. The performance tool 242 might therefore recommend a course of action designed to acquire additional or different information designed to eliminate one or more of the potential pathologies and thereby increase the likelihood of a correct identification. Thus, some embodiments of the present invention can “vector” through the pool of potential pathologies represented by the pattern signatures to improve the likelihood of a correct diagnosis.

The autonomous adaptation (at 309, in FIG. 3) will be implementation specific depending on what scenario may be developing. Exemplary adaptations may include, for example, varying the frequency of sampling, varying a metric for the computing resource being monitored, and monitoring the performance of the computing system with respect to another computing resource. It should be appreciated that this list is exemplary only, and is not exhaustive. Typically, the adaptation will involve a combination of these types of actions.

Some embodiments test the data and react to unknown patterns. The performance tool 242 may detect a pattern in the data through statistical analysis, for instance, that fails to correlate to any of the known pattern signatures. In one variation, the performance tool 242 flags the data set in which the unknown pattern is detected for review by a user and/or notifies the user that an unknown pattern has been detected. In another variation, the performance tool 242 locates a “closest match” from among the known pattern signatures and implements the adaptation recommended for that particular signature pattern. Alternatively, the performance tool 242 may include a number of pattern signatures that will return a recommended adaptation in the event an unknown pattern is detected. Typically, the recommendation in this latter implementation will be designed to acquire new or additional information that might produce a correlation.

To further an understanding of the present invention, one particular implementation of the illustrated embodiment will now be disclosed relative to FIG. 4-FIG. 6. FIG. 4 depicts an exemplary computing system 400 whose performance is monitored by a computing apparatus 403. The computing system 400 represents a theoretical, simplified network topology implementing the TPC Benchmark™ W (“TPC-W”), an eBusiness benchmark sponsored by the Transaction Processing Performance Council. A typical implementation of the computing system 400 might include, for example, as many as 200 processor nodes, 500+ disks, and numerous network switches, although only selected portions of such an implementation are shown in FIG. 4. The computing system 400 includes a plurality of image servers 406, at least one DNServer 409, a plurality of transaction servers 412, at least one data base server (“DBServer”) 415 including a plurality of disk racks 418, a plurality of web servers 421, a plurality of web caches 424, a plurality of remote browser emulators 427, and a network switch complex 430. This multi-tiered configuration contains heterogeneous hardware, operating systems, and applications glued together with implementation specific software. The remote browser emulators 427 simulate large numbers of users running through realistic random web interactions (e.g., browse, buy, administer functions).

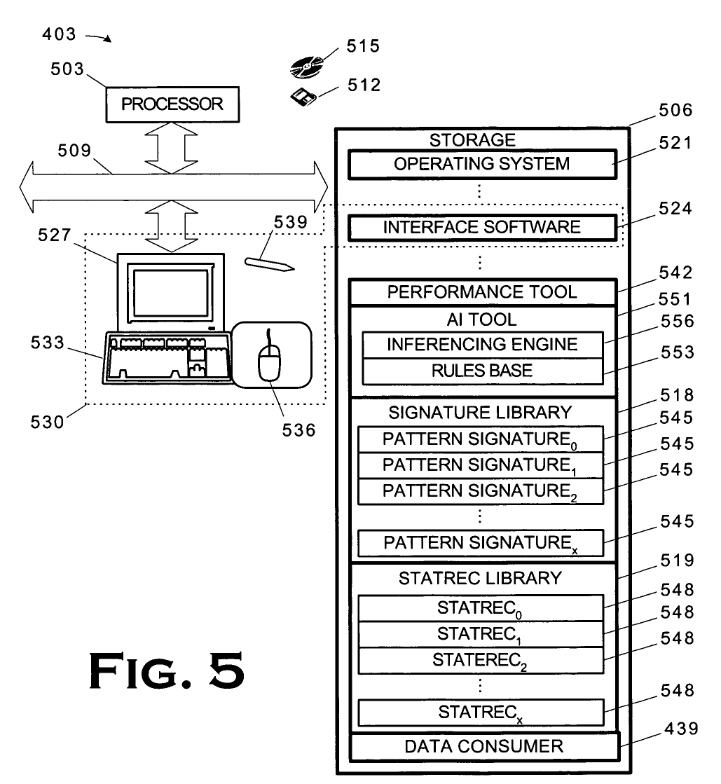

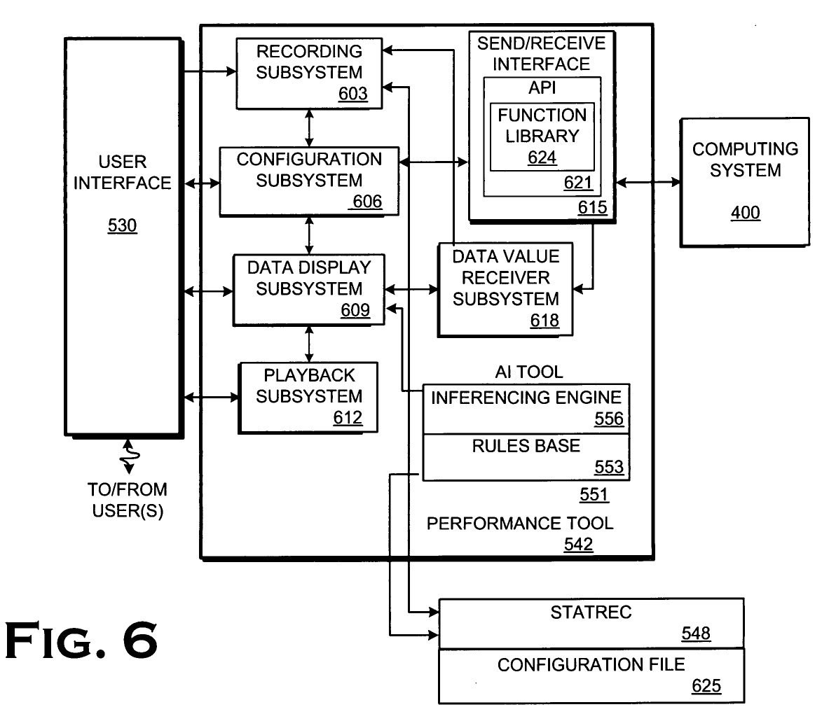

FIG. 5 depicts, in a block diagram, selected portions of the computing apparatus 403, first shown in FIG. 4. The computing apparatus 403 includes a processor 503 communicating with some storage 506 over a bus system 509. The processor 503 may be any suitable kind of processor known to the art, e.g., a digital signal processor (“DSP”), a graphics processor, or a general purpose microprocessor. In some embodiments, the processor 503 may be implemented as a processor set, such as a microprocessor with a graphics or math co-processor. The storage 506 may be implemented in conventional fashion and may include a variety of types of storage 506, such as a hard disk and/or RAM and/or removable storage such as the magnetic disk 512 and the optical disk 515. The storage 506 will typically include both read-only and writable memory, implemented in disk storage and/or cache. Parts of the storage 506 will typically be implemented in magnetic media (e.g., magnetic tape or magnetic disk) while other parts may be implemented in optical media (e.g., optical disk). The present invention admits wide latitude in implementation of the storage 506 in various embodiments. The bus system 509 may operate in accordance with any suitable protocol known to the art.

The storage 506 is encoded with one or more data structures used as a signature library 518 and a Statistical Record, or “StatRec” library 519 employed in the present invention as discussed more fully below. The storage 506 is also encoded with an operating system 521 and some interface software 524 that, in conjunction with the display 527, constitute an user interface 530. The display 527 may be a touch screen allowing the user to input directly into the computing apparatus 403. However, the user interface 530 also may include peripheral input/output (“I/O”) devices such as the keyboard 533, the mouse 536, or the stylus 539.

The processor 503 runs under the control of the operating system 521, which may be practically any operating system known to the art. The illustrated embodiment employs a UNIX operating system, but may be, for example, a WINDOWS-based operating system in alternative embodiments. The processor 503, under the control of the operating system 521, invokes the interface software 524 on startup so that the user (not shown) can control the computing apparatus 403. In the illustrated embodiment, the user interface 530 comprises a graphical user interface (“GUI”), although other types of interfaces may be used.

A performance tool 542 in accordance with the present invention also resides in the storage 506. The performance tool 542 is invoked by the processor 503 under the control of the operating system 521 or by the user through the user interface 530. The performance tool 542 may be used to generate and populate the signature library 518 with the pattern signatures 545 generated in some embodiments, as described more fully below. In the illustrated embodiment, the performance tool 542 also generates and populates a StatRec library 519 with a plurality of StatRecs 548, also as described more fully below.

As mentioned above, the functionality associated with the computing apparatus 403 may be distributed across a computing system instead of centralized in a single computing apparatus. Thus, alternative embodiments may, for instance, distribute the performance tool 542, the signature library 518, and the StatRec library 519 across, for example, the computing system 400, shown in FIG. 4. Some embodiments may even omit the StatRec library 519 altogether. However, the illustrated embodiment centralizes these components on a single computing apparatus 403 to clarify the illustration and thereby facilitate the disclosure of the present invention.

The StatRecs 548 contain data representing selected metrics of various resources of the computing system 400. Each grouping of metrics is called a StatSet. The header section of a StatRec defines the metrics in the grouping, sampling frequency, value types, and other data characterizations, which together define a StatSet. At each data sample, a value for each metric is appended onto the StatRec. A StatRec can be written to a permanent storage device for post processing. StatRecs 548 are used to create Pattern Signatures 545.

Returning to FIG. 4, the computing system 400 comprises a variety of different types of resources, such as network nodes, CPUs, memory, processes, etc., only some of which are shown. Some resources are hardware components and some are software components. These resources represent different contexts for the collection of performance data, and the computation of performance statistics. The computing environment can be decomposed into successively smaller and smaller components, and the decomposition defines a hierarchy of these performance analysis contexts. In the performance tool 542 of the illustrated embodiment, the statistics are associated with particular contexts, and these contexts are identified by listing all the contexts traversed in going from the top-level context to that particular context.

For example, in FIG. 4, the data base server 415 may be a host called “ultra” and includes a disk (non-removable) 433 designated “hdisk0” in a disk rack 436, which is a particular one of the disk racks 418, designated “disks”. In the case of a network-based computing environment, the disk 433 called “hdisk0” on the host data base server 415 called “ultra” could be referenced by using the following path:
/hosts/ultra/disks/hdisk0
   The statistic for the number of read operations on this disk 433 can then be referenced by adding the statistic name to the above path, i.e., the statistic name “reads”:
/hosts/ultra/disks/hdisk0/reads
   Note that this approach can be used to generate groups of uniquely identified data sets associated with a single resource. For example, a statistic for the number of write operations on the disk 433 can be reference as:
/hosts/ultra/disks/hdisk0/writes
   Still other statistics might be of interest, monitored, and referenced in this manner. In the illustrated embodiment, each of the metrics comprising a member of a StatSet in a StatRec 548 is identified by a pathname reflecting the context of its collection in the manner described immediately above.

Note that the set of hosts and other resources on the computing system 400, as well as its configuration, may vary greatly from environment to environment and from time to time. Furthermore, the performance tool 542, shown in FIG. 5, may be faced with the problem of monitoring entities that are created dynamically and disappear without warning. For instance, the execution of a given processing task may spawn the creation of one or more processes that are terminated upon completing the processing task. The existence of these processes may not be readily identifiable a priori. A statically defined context hierarchy may therefore be inadequate in some embodiments. Thus, the context hierarchy of the illustrated embodiment is dynamically created and modifiable at execution time in these embodiments.

In the illustrated embodiment of the performance tool 542, this problem is handled by using an object oriented model, although this is not necessary to the practice of the invention in all embodiments. In this model, a generic hierarchy of performance statistics contexts is defined using a hierarchy of context classes. Statistics are attributes of these classes, and generally all instances of a particular context class will have the same set of statistics. For example, the statistics relevant to the class of “disks” might include: “busy time”, “average transfer rate”, “number of reads”, “number of writes”, etc. Each class also has a “get.sub.--data( )” method (i.e., function) for each statistic, which can be called whenever that statistic needs to be computed.

In the illustrated embodiment of the performance tool 542, context classes also contain an “instantiate( )” method, which is called to create object instances of that class. For example, this method could be used for the class of “disks” to generate performance analysis contexts for collecting data on each disk in a particular system, (e.g., “hdisk0”, “hdisk1”, etc.). These disk contexts would all have the same set of statistics and “get.sub.--data( )” methods, which they inherit from the “disks” class.

The metrics are performed by and the data collected, in this particular embodiment, by a plurality of background processes 439, 442 (only one indicated), shown in FIG. 4. As noted relative to FIG. 5 above, the operating system 521 of the illustrated embodiment is a UNIX operating system, and such background processes are known as “daemons.” In UNIX, a daemon generally is a process that runs in the background and performs a specified operation at predefined times or in response to certain events. The term daemon is a UNIX term, and many other operating systems provide support for daemons, though they're sometimes called other names. WINDOWS, for example, refers to daemons as “system agents” and “services.” Herein, the terminology “background process” will be used.

In FIG. 4, the background process 439 is a “Data Consumer” (“DC”) running on the computing apparatus 403 and the background processes 442 are “Data Suppliers” (“DS”) monitoring computing resources and their utilization. The Data Consumer 439 is a server application and the Data Suppliers 442 are client applications. More particularly, each of the Data Suppliers 442:
organizes its statistical data in a hierarchy to provide a logical grouping of the data as discussed more fully below;
presents what metrics it has available upon request over the computing system 400 and on a selective basis;
accepts subscriptions for a continuous flow of one or more sets of performance data at negotiable frequency; and
provides for dynamic extension of its inventory of metrics through a simple application programming interface.
   The Data Consumers 439 may use the application programming interface to negotiate the set(s) of metrics, i.e., StatSets, in which it is interested with one or more of the Data Suppliers 442 to receive, process, display, and take corrective action based on the metrics as they are received from the Data Supplier(s) 442 over the computing system 400.

The Data Consumer 439 does not need any prior knowledge of the metrics available from the Data Suppliers 442. This helps in that not all hosts in the computing system 400 will have identical configurations and abilities and thus can not supply identical collections of metrics. To alleviate this ignorance, the Data Consumer 439 negotiates with potential Data Suppliers 442 using, in the illustrated embodiment, a low cost, Transmission Control Protocol (“TCP”)/User Datagram Protocol (“UDP”) based protocol with the following message types:
“control messages” to identify potential Data Suppliers in the computing system 400 and to check whether partners are still alive;
“configuration messages” to learn about the metrics available from identified Data Suppliers 442 and to define subscriptions for data;
“data feed” and “feed control” messages to control the continuous flow of data through the computing system 400; and
“status” messages to query the status of a Data Supplier 442 to register additional metrics with the Data Supplier 442.
   Note that other protocols and/or other message types may be employed in alternative embodiments.

The protocol of the illustrated embodiment allows for up to 24 individual values being grouped into a set and sent across the network in a single packet. A value is the finest granularity of statistic being monitored and has attributes associated with it. The simple application program interface hides the protocol from the application programmer and isolates it from application programs. This isolation largely makes application programs unaware of future protocol extensions and support for other base protocols.

Note that the number and association of the background processes 439, 442 will be implementation specific. For ease of illustration, the background processes 439, 442 are shown in one-to-one association with the various elements of the computing system 400 and the computing apparatus 403. However, the invention is not so limited. Alternative embodiments may employ more than one Data Consumer 439, or have an unmonitored resource in the computing system 400, or may employ multiple Data Suppliers 442 for a single resource. Some alternative embodiments may employ varying combinations of these variations.

The performance tool 542, first shown in FIG. 5, acts on the data collected by the background processes 439, 442 as generally described above. In the illustrated embodiment, the data is grouped into “StatRecs” 548 of mixed type for a particular node in the computing system 400, shown in FIG. 4, and preferably with the same sampling frequency. Note, however, that in some complex computing systems, multiple StatRecs 548 sampling at different frequencies may be desirable. In general, the StatRecs 548 are setup to characterize resource metric-based scenarios (e.g., CPU, Disk, Memory, Network, Locks, etc.); application derived scenarios (e.g., over varying loads: minimum, maximum, expected); or end-to-end transactions scenarios (which may span multiple applications over multiple machines). For complex configurations, multiple StatRecs will be useful in properly characterizing a scenario. These categorizations are neither exclusive nor exhaustive, and other categorizations may prove useful in other embodiments.

A Pattern Signature 545 is a “Zero time-based” recorded sample or “equation” generally derived from a StatRec. Pattern Signatures can be of varying time duration and are used to “match” against live or recorded StatRec data. StatRecs 548 can be subdivided into “frames” (of fixed or variable length) for finer decomposition in to unique patterns (e.g., “strokes”, “radicals”, “characters”) that can be uniquely identified. A signal “stroke”, the most basic frame, might be, for example: an increasing or decreasing value, a constant value. A series of “strokes” could be identified as a unique “radical” (or “character”). Groups of “radicals” would define “words”, groups of “words” phrases, sentences, paragraphs, etc.

These constructs represent the degree of pattern match and correspondingly a matching scenario. At the level of “strokes” representing pairs of data points as a “vector” can help normalize StatRec value data. A string of “vectors” with some “tolerance factor” can be useful when applying “fuzzy logic” to identify a pattern in a StatRec. Vector string characterizations allows the abstraction of “parochial” architectures (specific hardware and software) to “agnostic” architectures (non-specific hardware and software) based on application execution characteristics. This technique can be used if an application accesses generic or virtual resources in the same sequential manner in all execution environments. This can be a critical factor in recognizing and characterizing behavioral patterns in heterogeneous networked environments.

A unique sequence of frames from a Pattern Signature can identify a pattern of behavior. Contextual information, such as the application, Operating System, load factors, tuning factors, etc. can be associated statically or dynamically to further characterize or distinguish a signature. Once signals are encoded into a character string, they can be digitally processed and used for dynamic pattern matching. Note that the pattern matching process (comparing StatRecs against Pattern Signatures) should account for non-linear behaviors such as signal gaps, signal biases, noise, delayed signals, and signal terminations in the StatRecs data. Exemplary Pattern Signatures 545 may include, for example, (a) CPU kernel, user, wait, and idle statistics for a processor, or (b) disk busy, bytes read, bytes written for a disk, or (c) transmission control protocol (“TCP”) bytes sent, TCP bytes received, or some combination of these metrics.

One particular implementation of the performance tool 542 is shown in FIG. 6. In general, this particular implementation of the performance tool 542 comprises:
a recording subsystem 603, which records collected data as it is received from the computing system 400;
a configuration subsystem 606, through which a user can configure the performance tool 542 to monitor selected aspects of the operation of the computing system 400;
a data display subsystem 609, through which the performance tool 542 can, in conjunction with the user interface 530, display collected data to the user;
a playback subsystem 612,
a send/receive interface 615, including an application program interface (“API”) 621, through which the various components of the performance tool 542 communicate with the computing system 400; and
a data value receiver subsystem 618.
   A brief discussion of each subsystem follows.

Through the graphical user interface 530, the user can configure the various aspects of the operation of the performance tool 542. For example, the user can design the monitoring devices to activate and close consoles (a display window that graphs the contents of one or more StatRecs 548), initiate the recording of console data, then playback that recording at a later time. A User can traverse the hierarchy of performance data available from any of the Data Suppliers 442, shown in FIG. 4, in the computing system 400. This is done when the user invokes the user interface 530 to access the configuration subsystem 606, and the send/receive interface 615 to request and receive this information from a remote DataSupplier 442.

The user interface 530 presents the user with a series of graphical menus (not shown) that allow a user to completely specify the appearance and contents of a graphical performance “console” through which the user may monitor the performance of the computing system 400. Via the menu selections, the user can create a new “console” (collection of StatRecs 548) window, add new “instrument” (StatRec data) subwindows, and add multiple instrument values (modify a StatSet) to any instrument. Values are individual statistics being monitored, displayed and/or recorded, and can include statistics for system elements such as CPU, memory, paging space, disk, network, process, system call, system I/O, interprocess communications, file system, communication protocol, network file system, or remote procedure calls. The user also has menu control over the colors, value limits, presentation style, sampling frequency, labeling, and other value attributes. The user interface sets up automated functions and intervenes when insufficient data is available for autonomous decisions to be made.

All this information is stored in an ASCII configuration file 625 residing in the storage 506, shown in FIG. 5, of the computing apparatus 403. The information is stored in “stanza” formats similar to Motif resource files. If the user wishes to access remote statistics, the remote nodes are contacted via the send/receive interface 615 to ensure that they are available and have the requested statistics generally specified by consoles in the local configuration file 625. After the user has made these selections through the user interface 530, the requested console is displayed and live data is fed to the graphics console. When the user is finished viewing the console, it can be “closed” or “erased”. Closing a console leaves the console available in the configuration file 625 for later activation and viewing. Erasing a console removes the console from the configuration file, so that it must be reconstructed from scratch.

When the user has designed the consoles, the final configuration can be written to the configuration file 625, so that future invocations of the performance tool 542 can obtain the configuration information by reading the file as the performance tool 542 begins operations. The configuration file 625 is an important tool for the performance tool user. The configuration file 625 may contain two types of information: information regarding executable programs and information regarding consoles.

There are, in this particular implementation of the illustrated embodiment, two types of consoles—fixed consoles and “skeleton” consoles. Fixed consoles access a predetermined set of performance data to monitor. Fixed consoles can be entered manually into the configuration file 625 or they may be saved as the result of an on-line configuration session with the user through the user interface 530. “Skeleton” consoles are monitoring devices wherein the exact choice of the performance data (m items out of n choices, e.g., 3 out of 5 processors) to display is left open to be specified by a user.

Most configuration tasks between a Data Consumer 439 and a Data Supplier 442 involve the exchange of configuration information through the computing system 400, shown in FIG. 4, using the send/receive interface 615, shown in FIG. 6, of the performance tool 542. Configuration-type messages are of the “request/response” type. This is also true for the unique messages that allow a user to traverse the hierarchy of performance data to see what's available before selecting data to display in consoles. A “request-response” type protocol is a two way communication between a client and a server. The Data Consumer 439 sends a “request for data” message to the Data Supplier 442 and then waits for a “response” from the server. If the server does not respond within a specified time limit, the client may attempt a retry or terminate with an error.

Finally, the configuration subsystem 606 supplies configuration information to the data display subsystem 609 whenever the user requests that a console be activated. When a user requests a “console” to be activated, the detailed console specifications that were originally read into memory from the configuration file 624 are passed to the data display subsystem 609 in a memory control block area. The configuration subsystem 606 can likewise pass skeleton console data that was read from the configuration file to the data display subsystem 609 in a memory control block area. The configuration subsystem 606 also provides the data display subsystem 609 with selection lists of possible performance data to present to the user to instantiate skeleton consoles.

The data display subsystem 609 displays the performance data in the format described by the configuration subsystem 606 when it is received from either the playback subsystem 612 or the data value receiver subsystem 618. Note that this capability is not necessary to the practice of the invention and may be omitted in some embodiments. Still referring to FIG. 6, the data display subsystem 609 interfaces to the configuration subsystem 606, the playback subsystem 612, the data value receiver subsystem 618, and the user interface 530. The data display subsystem 606 primarily receives information from the playback subsystem 612 and the data value receiver subsystem 618.

For the data display subsystem 609, the configuration subsystem 606 is a supplier of configuration information and a vehicle for traversing the hierarchy of the performance data. The former is used to construct the windows and subwindows of monitoring devices on the graphical display; the latter is used to present lists of choices when a skeleton console is created or when designing or changing an ordinary console. The traversal of the data hierarchy requires the exchange of network messages between the configuration subsystem 606 and the Data Suppliers 442, shown in FIG. 4, using the send/receive interface 615. Requests to start, change, and stop feeding of performance data are also passed from the data display subsystem 609 to the configuration subsystem 606 through the send/receive interface 615 to the Data Suppliers 442.

Data flow on the interface 615 to the data value receiver subsystem 618 is unidirectional, always from the data value receiver subsystem 618 to the data display subsystem 609. As data packets are received from the send/receive interface 615, the data value receiver subsystem 618 uses the StatSet identifier (“StatSetID”) from the received packets to perform a lookup in a list of all active display consoles from a common parameter storage area (not shown), get a pointer to the console control block, and pass the information to the data display subsystem 609.

The playback subsystem 612 mimics the data value receiver subsystem 618. Where the latter receives packets of data over the network, the playback subsystem 612 reads them from the StatRec 548 and hands them to the data display subsystem 609 in the same data format that the data value receiver subsystem 618 uses. This allows the data display subsystem 609 to handle the two data sources as if they were the same.

Several other capabilities of the performance tool 542 implemented in the data display subsystem 609 include the ability to change graph styles, to tabulate data, and instantiate skeleton consoles. More particularly:
the user may direct the data display subsystem 609 to change the graph style of any monitoring instrument in any console (e.g., data viewed as pie chart graph in one second may be viewed as a time-scale graph the next);
any monitoring instrument may be told to tabulate the data it receives in addition to showing the received data in a graph. Tabulation is done in special windows and can be turned on and off by the user with a couple of mouse clicks; and
whenever the user wants to instantiate a skeleton console, the data display subsystem 609 will use the user interface 530 to present a list of possible data values to the user. The user then selects the desired data from a list (not shown), and an instantiated console is created. The contents of the selection list depend on how the skeleton console is defined in the configuration file 625 and may represent any node (context) in the data hierarchy that may vary between hosts or between multiple/differing executions of the performance tool.
   These graphic facilities are useful for users to recognize and identify patterns associated with pathologies. Most Pattern Signatures 545 will be based on user recognition and classification of patterns. These graphical techniques can also be used for unknown pattern classification. Once Pattern Signatures 545 have been classified, they can be processed autonomously. The implementation of these capabilities depends on the user interface 530 as the vehicle for the user to communicate his or her wishes.

Still referring to FIG. 6, the recording subsystem 603 is controlled from the user interface 530 to request a “recording” of collected data. The recording subsystem 603 will, for each console that has recording activated, be passed the actual data feed information from the data value receiver subsystem 618. As long as recording is active for a console, data is passed along and stored by the recording subsystem 603.

When a recording is requested, the StatSet graphical configuration information (not shown) and StatSet data values are stored in a StatRec 548. This configuration and data value information is extracted from the current in memory control blocks and consists of the following control blocks:
console information, which describes the size and placement of the monitoring console's window;
instrument information, which describes each of the monitoring console's monitoring instruments, including their relative position within the monitor window, colors, tiling, etc.;
value display information, which describes the path name, color, label and other information related to the display format of each of the statistics values displayed in the monitoring instruments; and
value detail information, which gives information about a statistics value that is independent of the monitoring “instrument” in which the value is being used. This includes the value's descriptive name, data format, etc.
   The actual data recording uses a fifth and final control block format. This format allows for variable length blocks to be written to preserve file space. This design also keeps data volume requirements down by referring each data recording data block symbolically to the configuration information in the StatRec 548, rather than storing long identifiers.

Still referring to FIG. 6, the playback subsystem 612 can realistically playback from any StatRec 548. The playback subsystem 612 can also search for time steps in a recording with data from many hosts, each of which had different clock settings when the recording was created. Other than that, the playback subsystem 612, as seen from the data display subsystem 609, is just another supplier of data packets (not shown). The packets are read from the StatRec file 548 at the speed requested by the user and fed to the data display subsystem 609. The user interface 530 is the only other subsystem interfacing with the playback subsystem 612, and allows the user to:
select which recordings to play back from a list of recordings;
play the recording and increase or decrease the playback speed;
rewind the recording or forward the recording to any time stamp; and
erase a selected recording

Referring again to FIG. 6, the data value receiver subsystem 618 receives data feed packets arriving from the computing system 400 and forwards a copy of each data feed packet to the interested subsystems 603, 606, 609, 612. Before the data packet is passed on, it is tagged with information that identifies the target console to which it is intended. If no target can be found, the data packet is discarded. The send/receive interface 615 uses the API library functions 624 to access the computing system 400. This includes the API callback function that gets control whenever a data feed package is received. The data value receiver subsystem 618 is the only function that will ever receive data packets at the interface 615 in the performance tool 542. The data value receiver subsystem 618 does not have to poll but is scheduled automatically for each data feed packet received. Since the data feed packets do not require a response, their communications with the send/receive interface 615 is unidirectional. Because of this unidirectionality and lack of polling/responses, data packets can be supplied at very high data rates, thus allowing for real time monitoring of remotely supplied statistics.

When a data packet is received, the data value receiver subsystem 618 consults the tables of active consoles (not shown) as maintained by the data display subsystem 609. Data packets that cannot be related to an active monitoring console are discarded, assuming they arrived after the console was closed. If a console is identified, the recording subsystem 603 is invoked if recording is active for it. The data packet is then passed to the data display subsystem 609 where further decoding is done as part of the actual display of data values. This design thus provides the ability to concurrently display and record local and remotely supplied performance statistics in real-time. If a data packet is identified as belonging to a monitoring console that is being recorded, the recording subsystem 603 is invoked to write a copy of the data packet to the StatRec 548. If recording is only active for some of the instruments in the console, only data belonging to those instruments is actually written to the StatRec 548.

Still referring now to FIG. 6, the send/receive interface 615 consists of (i) the library functions 624 for the API 621, and (ii) code (not shown) written for the monitoring program of the performance tool 542 to invoke the API library functions 624. The send/receive interface 615 has several responsibilities, the most prominent of which include identifying Data Suppliers 442, traversing the data hierarchy, negotiating statistics sets, starting and stopping data feeding, keeping connections alive, and processing data feed packets.

The interface uses a broadcast function of the API 621 to identify the Data Suppliers 442 available in the computing system 400. Invitational packets are sent to remote hosts as directed by the API “hosts file” (not shown), where the user may request broadcasting on all local interfaces and/or request specific hosts or subnets to be invited. The API “hosts file” is a file that can be set up by the user to specify which subarea networks to broadcast the invitation “are-you-there” message. It can also specify individual hosts to exclude from the broadcasts. Invitational broadcasts are conducted periodically to make sure all potential Data Supplier hosts are identified.

The API request/response interface 621 is used to traverse the data hierarchy whenever the user requests this through the user interface 530 and the configuration subsystem 606.

For each instrument that is activated by the user, the API 621 is used to negotiate what data values belong to the set. If one of the Data Suppliers 442 is restarted, the performance tool 542 uses the same interface to renegotiate the set. While data feeding is active, and in certain cases when it is not, both the performance tool 542 and the Data Suppliers 442 keep information of the set. The Data Suppliers 442 do not know what data values to send, while the configuration subsystem 606 needs the information so it can instruct the data display subsystem 609 what is in the data packet.

The data display subsystem 609, as instructed by the user through the user interface 530, will pass requests for start, stop, and frequency changes for data feed packets through the configuration subsystem 606 to the send/receive interface 615, using the API 621.

The API 621 includes functions to make sure active monitors are known by the Data Suppliers 442 to be alive. These functions are handled by the API function library 624 without interference from the performance tool 542.

Data feed packets are received by the API library functions 624 and passed on to the data value receiver subsystem 618 for further processing. No processing is done directly in the send/receive interface 615.

The user interface 530 allows the user to control the monitoring process almost entirely with the use of a pointing device (e.g., a mouse or trackball). The user interface 530 uses menus extensively and communicates directly to the recording subsystem 603, the configuration subsystem 606, the data display subsystem 609, and the playback subsystem 612.

With respect to the recording subsystem 603, the user interface 530 allows the user to start and stop recording from any active monitoring console and any active monitoring instrument. When recording begins in the recording subsystem 603, the configuration of the entire monitoring console is written to a StatRec 548. The StatRec 548 is named from the name of the monitoring console from which it is being recorded. As all information about the monitoring console's configuration is stored in the StatRec 548, playback can be initiated without a lengthy interaction between user and playback subsystem 612. Through the user interface 530, the user can start and stop recording as required and if a recording file already exists when recording is requested for a monitoring console, the user is given the choice of appending to the existing file or replacing it.

The configuration subsystem 606 has two means of acquiring information about the monitoring of consoles and instruments. First, a configuration file 625 can contain configuration information for many monitoring devices. These may be skeleton consoles or may be fixed consoles. Second, the user can add, change, and delete configuration about fixed consoles directly through the user interface 530. Whether configuration information is read from the configuration file 625 or established in interaction with the user, it causes configuration messages to be exchanged between the configuration subsystem 606 and the send/receive interface 615 and the remote Data Suppliers 442.

The skeleton consoles are monitoring devices where the exact choice of the performance data to display is left open. To activate a skeleton console, the user must specify one or more instances of the available performance data, such as the processes, the remote host systems, or the physical disks to monitor. Each time a skeleton console is activated, a new instance is created. This new instance allows a user to activate multiple, similar-looking consoles, each one monitoring different performance data, from one skeleton console.

In addition to configuring of monitoring devices, the user uses the user interface 530 to activate or close monitoring devices, thereby causing network messages to be exchanged between the configuration subsystem 606 and the send/receive interface 615. These messages consist largely of instructions to the remote Data Suppliers 442 about what performance data to send and how often. The data display subsystem 609 receives information about monitoring devices from the configuration subsystem 606 and uses this information to present the user with a list of monitoring devices for the user from which to select. In the case of skeleton consoles, the user interface 530 will also present a list of the items from which the user can select when instantiating the skeleton console.

Finally, the user interface 530 is used to start the playback of recordings. Recordings are kept in disk files (e.g., the StatRec 548) and may have been created at the same host system that is used to play them back, or may have been generated at other hosts. This flexibility allows a remote customer or user to record the performance data for some workload and mail the performance data to a service center or technical support group to analyze. The recordings contain all necessary information to recreate exact replicas of the monitoring consoles from which they were recorded. When a StatRec 548 is selected for display, the imbedded configuration data is passed on to the data display subsystem 609 and a playback console is constructed on the graphical display. Once the playback console is opened, the user can play the recording at almost any speed, can rewind, search for any time stamp on the recording, erase the recording and stop the playback of the recording.

Note that, although the illustrated embodiment provides many opportunities for a user to interface and control or influence the monitoring operation's various stages, this is not necessary to the practice of the invention. Returning to FIG. 5, the performance tool 542 may be invoked by the operating system 521 on startup. The performance tool 542 can initiate a monitoring scheme from a preloaded configuration file 625, shown in FIG. 6, including instantiating the Data Consumer 439 and the Data Suppliers 442. The performance tool 542 can then adaptively and autonomously monitor the performance of the computing system 400. The performance tool 542 can also then autonomously implement corrective actions responsive to the adaptive monitoring. Thus, although the illustrated embodiment provides ample opportunity for user input, such is not required in all embodiments of the invention.

Thus, the performance tool 542, shown in FIG. 5, receives data associated with monitoring performance of at least a portion of the computing system 400, illustrated in FIG. 4, through the Data Consumer 439 and Data Suppliers 442. The Data Consumer 439 and Data Suppliers 442 collect and send this data in accordance with a monitoring scheme. The monitoring scheme may be manually instantiated by a user through the data display and configuration subsystems 609, 606, shown in FIG. 6, of the performance tool 524 as described above. Alternatively, an initial monitoring scheme may be predefined and instantiated by the performance tool 542 on startup by the operating system 521.

The performance tool 542 receives the data through the send/receive interface 615, shown in FIG. 6, as described above, and the data is stored by the recording subsystem 603 in the storage 506, shown in FIG. 5, also as described above. As previously mentioned, the data is collected and stored in “StatRecs” 548. The StatRecs 548 are stored in a StatRec library 518. The previously developed pattern signatures 545 are stored in a signature library 518. In the illustrated embodiment, the StatRecs 548 can be accumulated into larger groupings to permit aggregated views of metrics that may not be naturally associated with each other or containable within a single StatRec 548. StatRecs 548 can record identical sets of metrics (StatSets) but be uniquely different because of their recording periods, frequencies, and execution environments.

Some patterns may be sufficiently predictable or reproducible that a simple comparison and matching techniques will suffice. Typically, however, system resource utilization patterns will rarely be absolutely reproducible or predictable, so that a simple comparison and matching technique will be inefficient for most embodiments. Accordingly, the performance tool 542 includes an AI tool 551 that compares the StatRecs 548 stored in the StatRec library 519 with pattern signatures 545 stored in the signature library 518. Comparisons are not necessarily for an exact match, but often merely determines when measured utilization patterns (represented by the StatRecs 548) are “close enough” or are “within tolerance” of the pattern signatures 545.

In the illustrated embodiment, the AI tool 551 employs a fuzzy logic process, although other AI techniques may be employed in alternative embodiments. The AI tool 551 therefore includes a rules base 553 and an inferencing engine 556. In general, fuzzy logic systems consist of: input variables, output variables, membership functions defined over the variables' ranges, and fuzzy rules or propositions relating inputs to outputs through the membership functions. In general, the input variables for the illustrated embodiment are the data in the StatRecs 548, the output variables are recommended actions, and the membership functions are qualitative assessments.

The nature of these quantities will depend to some degree on the nature of the metric being considered. For instance, a metric for “CPU usage” may be included in a given StatRec 548, and thus constitute an “input variable.” In general, CPU usage should not be so high that processes are waiting for CPU nor so low that some pathology might be developing or occurring. Thus, membership functions for “CPU usage” may include, for example: “high”, in which it needs to be monitored more closely; “acceptable”, in which the current operational state does not need further attention; and “low”, in which it needs to be monitored more closely.

Consider an example in which “high” CPU usage is defined to be CPU usage exceeding 90% for 5 minutes and “acceptable usage” is defined to be less than 60% for 10 minutes. In this example, a fuzzy logic rule might look something like:
if global CPU usage on system high, then sample individual CPUs at 1 second intervals, off-load jobs to system B, and reset normal sampling when global CPU usage is acceptable
   Technically, the portion of each rule between the “if” and the “then” inclusive is the rule's “premise” or “antecedent.” and the portion of the rule following the “then” is the rule's “conclusion” or “consequent.” This rule's consequent states three recommended actions, which are the “output variables” for this rule. Note that the definitions of the membership functions provide some flexibility in tuning the performance of the computing system 400 by tweaking the definitions of the membership functions.

The formulation of the individual rules and the compilation of the rules base 553 is performed a priori by a systems expert. Note that the formulation of the rules will incorporate the salient and/or defining features of the pattern signatures 545. Thus, in embodiments employing fuzzy logic, the signature library 518 and pattern signatures 545 may be omitted once the rules base 553 is formulated. However, the illustrated embodiment retains the signature library 518 as a convenience for situations in which the user may wish to manually review data and diagnose operational behaviors.

Details of a particular fuzzy logic process can be found in either of the commercially available, off-the-shelf software packages or any other fuzzy logic tool that may be known to those skilled in the art. Numerous commercially available, off-the-shelf software packages can be used to perform the necessary comparison, i.e., execution of the fuzzy logic process, perhaps with some modification. Among these are:
“CubiCalc,” available from Hyperlogic Corporation, 1855 East Valley Parkway, Suite 210, P.O. Box 300010, Escondido, Calif. 92039-0010; and
“MATLAB,” with the add-in module “Fuzzy Logic Toolbox,” available from The Math Works, Inc., 24 Prim Park Way, Natick, Mass. 01760.
   However, still other software packages may be used.

The inferencing engine 556 inferences on each of the rules in the rules base 553 to obtain a crisp measure of the degree of correspondence between a given StatRec 548 and the pattern signatures 545. Thus, in the illustrated embodiment, each StatRec 548 is evaluated against a plurality of potential pattern signatures 545 and the inferencing is performed for each of the pattern signatures 545. The illustrated embodiment therefore will yield a plurality of likelihood indications, one for each potential pattern signature 545.

A recommended action is then identified from the output indications of likelihood in some embodiments of the invention. This identification may be performed in a number of ways depending on the particular implementation. For instance, the potential identification having the highest likelihood of match might be selected as the corresponding pattern signature 545. Regardless, the scope of the invention is not limited as to how the identification is made from the indications of likelihood. The recommended actions will vary depending on the nature of the pathology. Tables 1-3 set forth exemplary pathologies and actions that might be recommended to rectify them.

TABLE 1
Hardware Failures & Unbalanced Demand/Capacity Pathologies

| Pathology | Recommended Action |
|---|---|
| CPU, Disk, Network | Physically or Logically Substitute and/or |
| Adapter, Switch, | Replace Failed Components with Spares |
| Cable, Memory Module, | |
| Power Supply, and | |
| Node Failures | |
| Unbalanced Hardware | Provision additional hardware to meet demand |
| Demand/Capacity | or Add and Remove Components to Achieve |
| | Price/Performance Total Solution Balance |
| Excessive Disk Busy on | Redistribute disk load, provision more disks, or |
| Selected Disks in a | Adjust Data Base Layout and Position on the |
| Data Base | Disks to Minimize Disk Head Movement |
| (Unbalanced Data) | |

TABLE 2
Software Failures & Untuned Software Pathologies

| Pathology | Recommended Action |
|---|---|
| Occasional Application | Provision more memory or fix memory leak |
| Memory Leaks | bug and Reboot Machine with Memory Leak |
| Image Cache Miss After | Fix Bug in Memory Cache Logic and Adjust |
| Images All Cached | Tuning Parameters or provision more cache |
| Unbalanced Web Cache | Provision More Web Caches to Balance Load |
| Hits | and Adjust Configuration Tuning Parameters |
| Unbalanced Transaction | Adjust Transaction Distribution Algorithm and |
| Server Loads | Tuning Parameters to Even the Load Across |
| | Transaction Servers |
| Data Base Deadlocks | Adjust Data Base Layout to remove |
| | contentions |
| Poor Performance | Replace Webserver with More Efficient |
| Scaling for Connection | Webserver |
| Thread Pool Processing | |
| (High Kernel CPU to | |
| Process, large Number | |
| of connection threads) | |
| Transactions Blocked | Provision additional Down Line Resources to |
| Due to Down Line | Remove Bottleneck |
| Resource Bottlenecks | |

TABLE 3
Network/Communications Failures and Bandwidth
Limitation Pathologies

| Pathology | Recommended Action |
|---|---|
| Network Loads Exceed | Provision additional or Higher Bandwidth |
| Max Bandwidth/ | Adapters and Switches to Problem Nodes |
| Throughput Characteristics | and rebalance loads. |
| of Adapters and | |
| Switches Causing Loss | |
| of Data, Retransmissions, | |
| and Transmission Timeouts | |
| Daisy Chained Switches | Rewire Network Nodes to Minimize Daisy |
| Cause Bottlenecks at | Chain Bottlenecks or redistribute functions to |
| Some Connection Points | cluster network traffic to common switches |
| Excessive Switch Hops | Rewire Network Nodes to Minimize Switch/ |
| When Interacting | Blade hops for Majority of Transactions or |
| Network Nodes Are Not on | redistribute functions for same effect |
| the Same Switch or Blade | |
| Scaling Problem in Ability | Distribute Open Connections Over More |
| to Support Large Number | Machines to Reduce the Number of |
| of Open Connections | Connections per Machine |
| on Some Nodes | |
| Excessive Communication | Offload Network Traffic and Adjust Tuning |
| Errors | Parameters |

In the illustrated embodiment, the performance tool 542 autonomously adapts the monitoring scheme responsive to the determination of the AI tool 551 if the recommended action may be taken autonomously. Consider, again, the rule:
if global CPU usage on system high, then sample individual CPUs at 1 second intervals, off-load jobs to system B, and reset normal sampling when global CPU usage is acceptable
   Note that the rule contains three recommended actions: (1) sample individual CPUs at 1 second intervals, (2) off-load jobs to system B, and (3) reset normal sampling when global CPU usage is acceptable. All of these actions can be implemented autonomously and, in the illustrated embodiment, the performance tool 542 does so. Note that actions (1) and (3) affirmatively modify the monitoring scheme twice when implemented. First, individual CPUs are sampled at 1 second intervals until CPU usage is acceptable. Second, when CPU usage is acceptable, the monitoring scheme is returned to its originals settings, i.e., “normal” sampling.

As was earlier mentioned, this adaptive monitoring described immediately above can be used to vector through the pool of potential pathologies represented by the pattern signatures 545. For instance, in the example described immediately above, the monitoring scheme is autonomously adapted to sample individual CPUs at 1 second intervals. The corresponding Data Suppliers 442 begin acquiring additional data with this increased granularity. The performance tool 542 can then examine the new StatRecs 548 through application of the AI tool 551, as described above. The fuzzy logic process may return a determination that, for example, a pathology exists with respect to one or more CPUs that causes the overall CPU usage to elevate undesirably. For instance, one or more CPUs might have failed, and their load shunted onto other CPUs, thereby increasing the overall CPU load. In this manner, the performance tool 545 may be able to find the pathology underlying the pathology that was initially detected.

Also as was earlier mentioned, the performance tool 542 can, in the illustrated embodiment, detect unknown patterns suspected to be associated with some unspecified pathology. For instance, in the fuzzy logic process, the metrics of some StatRec 548 may be assigned to membership functions that are known to be undesirable. However, the fuzzy logic process may not be able to find a correspondence to a known pattern signature 545. In these circumstances, the StatRec 548 can be flagged and a user notified to examine the data manually.

The performance tool 542 sends the notification through the data display subsystem 609, shown in FIG. 6, and the user interface 530. The user can then use interface with the performance tool 542 through the user interface 530 and the playback system 612 to playback the StatRec 548 and, if desired, to overlay selected pattern signatures 545. In this manner, the user can attempt to formulate a desired course of action to adapt the monitoring scheme. Such an adaptation could be manually entered through the user interface 530 and the configuration subsystem 606.

In one implementation, the performance tool 542 catalogues the unknown pattern as a pattern signature 545 in the signature library 518. The new pattern signature 545 can be incorporated into the fuzzy logic process by formulating a new rule associating the new pattern signature 545 to a recommended action. The formulation may be manual or autonomous. If autonomous, the performance tool 542 can associate the user's response arrived at as described above with the new pattern signature. The performance tool 542 may also default the recommended action to user notification.

Thus, the present invention provides a method and apparatus for monitoring the performance of a computing system. The invention provides dynamic recognition of normal vs. abnormal patterns of behavior as well as predictive selection of the proper monitoring sets and frequencies. Upon recognition of abnormal or undesirable patterns of behavior, the invention adapts the monitoring scheme for the duration thereof and then returns to the “normal” monitoring scheme thereafter. Note that, in a real-world computing environment, the utilization patterns are usually complex and are compounded by multiple concurrent events. However, the present invention is able to filter out, identify and track individual threads of activities within the midst of such “noise.”

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for monitoring a performance of a computing system, comprising:
receiving data associated with monitoring performance of at least a portion of the computing device in accordance with a monitoring scheme;
detecting a pattern in the received data; and
autonomously adapting the monitoring scheme responsive to the detected pattern.

2. The method of claim 1, wherein receiving data associated with monitoring performance of at least a portion of the computing device comprises receiving data associated with monitoring performance of a computing resource.

3. The method of claim 1, further comprising at least one of:
modifying the performance of the computing device in light of a predicted behavior associated with the pattern; and
detecting an unknown pattern while autonomously testing the received data.

4. The method of claim 3, further comprising notifying a user of the detection of the unknown pattern.

5. The method of claim 1, wherein autonomously testing the received data comprises applying an expert system to the received data.

6. The method of claim 5, wherein applying the expert system comprises applying a fuzzy logic system.

7. The method of claim 1, wherein autonomously adapting the monitoring scheme comprises at least one of varying a frequency of sampling, varying a metric for the computing resource, and monitoring the performance of the computing device with respect to another computing resource.

8. The method of claim 1, further comprising modifying the performance of the computing device based on a predicted behavior associated with the pattern.

9. The method of claim 3, further comprising autonomously adapting the monitoring scheme responsive to detecting the unknown pattern.

10. An apparatus for monitoring a performance of a computing device, comprising:
an interface;
a control unit communicatively coupled to the interface, the control unit adapted to:
receive data over the interface, the data being associated with monitoring performance of at least a portion of the computing device in accordance with a monitoring scheme;
detect a pattern in the received data; and
adapt the monitoring scheme responsive to detecting the pattern.

11. The apparatus of claim 10, wherein the control unit is adapted to receive data associated with monitoring performance of a computing resource.

12. The apparatus of claim 10, wherein the control unit is further adapted to at least one of:
establish the monitoring scheme;
modify the performance of the computing device in light of a predicted behavior associated with the pattern; and
detect an unknown pattern while autonomously testing the received data.

13. The computing apparatus of claim 10, wherein the control unit is further adapted to apply an expert system to the received data.

14. The computing apparatus of claim 10, wherein the control unit is further adapted to at least one of vary a frequency of sampling, vary a metric for the computing resource, and monitor the performance of the computing device with respect to another computing resource.

15. A program storage medium encoded with instructions that, when executed by a computing device, perform a method for monitoring the performance of a computing device, wherein the encoded method comprises:
receiving data associated with monitoring performance of at least a portion of the computing device in accordance with a monitoring scheme;
autonomously testing the received data for a pattern in the monitored performance; and
autonomously adapting the monitoring scheme responsive to detecting the pattern.

16. The program storage medium of claim 15, wherein receiving data associated with monitoring performance of at least a portion of the computing device in the encoded method comprises receiving data associated with monitoring performance of a computing resource.

17. The program storage medium of claim 15, wherein the encoded method further comprises at least one of:
establishing the monitoring scheme;
modifying the performance of the computing device in light of a predicted behavior associated with the pattern;
comprising detecting an unknown pattern while autonomously testing the received data; and
detecting an unknown pattern while autonomously testing the received data.

18. The program storage medium of claim 15, wherein autonomously testing the received data in the encoded method comprises applying an expert system to the received data.

19. The program storage medium of claim 15, wherein autonomously adapting the monitoring scheme in the encoded method comprises at least one of varying a frequency of sampling, varying a metric for the computing resource, and monitoring the performance of the computing device with respect to another computing resource.
